(19) United States
(12) Patent Application Publication
(10) Pub. No.: US 2020/0050018 A1
(43) Pub. Date: Feb. 13, 2020

(54) HINGE ASSEMBLY FOR EYEWEAR

(71) Applicant: Pasquale MATERA, Plainview, NY (US)

(72) Inventor: Pasquale MATERA, Plainview, NY (US)

(21) Appl. No.: 16/505,676

(22) Filed: Jul. 8, 2019

Related U.S. Application Data
(63) Continuation of application No. PCT/US2018/012820, filed on Jan. 8, 2018.
Application No. PCT/US2018/012820 is a continuation of application No. 62/443,257, filed on Jan. 6, 2017.

(51) Int. Cl. G02C 5/22; G02C 5/14; G02C 11/04

(52) U.S. Cl. CPC G02C 5/22; G02C 11/04; G02C 5/14

(57) ABSTRACT

Eyewear with a frame and at least one arm is provided. The frame can include at least one cavity disposed at one side thereof. The cavity is formed adjacent a cutout in the frame. The at least one arm can be rotationally connected to the frame by a swivel portion. The swivel portion can be disposed and rotate within the cavity such that a plurality of surfaces of the swivel portion are viewable through the cutout.

This application is a PCT Bypass Continuation under 35 U.S.C. § 120 of PCT application no. PCT/US2018/012820, filed in the U.S. Patent & Trademark Office on Jan. 8, 2018, which in turn claimed priority under 35 U.S.C. § 119 to U.S. Provisional Patent Application No. 62/443,257 filed on Jan. 6, 2017, the priority to both of which are claimed herein and the contents of both of which are all incorporated in their entireties.

### FIELD

The present disclosure generally relates to eyewear, and more particularly, to a hinge assembly for eyewear.

### BACKGROUND

Eyewear generally includes a frame with a nose bridge and a pair of lenses on opposing sides thereof. A pair of arms typically extends rearward from the frame. The arms are typically attached to the frame by respective hinge assemblies that enable pivoting of the arms between a folded, or closed, position and an unfolded, or open, operational position for wearing by the user.

### SUMMARY

According to one aspect of the disclosed subject matter, eyewear with a frame and at least one arm is provided. The frame has at least one cavity disposed at one side thereof. The cavity is formed adjacent a cutout in the frame. The at least one arm is rotationally connected to the frame by a swivel portion. The swivel portion is disposed and can rotate within the cavity such that a plurality of surfaces of the swivel portion are viewable through the cutout.

According to another aspect of the disclosed subject matter, eyewear with a frame and a pair of arms is provided. Each arm is connected to the frame by a respective hinge. The eyewear includes a pair of connectors, each connector being attached to the frame and the respective arm to form the respective hinge. Each connector includes an elongated portion extending along and attached to a portion of the respective arm adjacent the frame. Each connector also includes a swivel portion connected to the elongated portion and disposed within a cavity in the frame. The swivel portion has a plurality of faces configured to be displayed through a cutout to the cavity in the frame, each of the plurality of faces being displayed at corresponding rotational positions of the swivel portion.

In yet another aspect of the disclosed subject matter, a method of using eyewear, comprising: providing a frame defining two lens supports and at least one cutout located adjacent at least one of the two lens supports, a first hinge connected to a first arm at one side of the frame, a second hinge connected to a second arm at an opposing side of the frame, a first decorative surface located adjacent the cutout, and a second decorative surface distinct from the first decorative surface located adjacent the cutout; rotating the first arm about the first hinge to a first position such that the first decorative surface is viewable through the cutout from a first vantage point, and such that the second decorative surface is obscured from view through the cutout from the first vantage point; and rotating the first arm about the first hinge to a second position such that the second decorative surface is viewable through the cutout from the first vantage point, and such that the first decorative surface is obscured from view through the cutout from the first vantage point.

These and other aspects, features and advantages of the present disclosed subject matter will be more clearly understood and appreciated from a review of the following detailed description of exemplary embodiments and appended claims, and by reference to the accompanying drawings.

### BRIEF DESCRIPTION OF THE DRAWINGS

FIG. 1 is a front left side perspective view of an embodiment of eyewear according to an aspect of the disclosed subject matter.

FIG. 2 is an enlarged perspective view of the embodiment of a hinge assembly of the eyewear of FIG. 1.

FIG. 3 is an enlarged perspective view of the hinge assembly of FIG. 1 with internal components shown in phantom.

FIG. 4 is an enlarged perspective view of an opposing hinge assembly of FIG. 1 with internal components shown in phantom.

FIG. 5 is an enlarged perspective view of the hinge assembly and portion of an extending arm of FIG. 1 in a folded or closed position.

FIG. 6 is a top view of the opposing hinge assembly and portion of an extending arm of FIG. 1 in an unfolded or open position with internal components shown in phantom.

FIG. 7 is a top view of the opposing hinge assembly and portion of the extending arm of FIG. 1 in the folded or closed position with internal components shown in phantom.

FIG. 8 is a front view of an embodiment of eyewear according to another aspect of the disclosed subject matter.

FIG. 9 is a side view of another embodiment of eyewear according to another aspect of the disclosed subject matter.

FIG. 10 is a front view of yet another embodiment of eyewear according to another aspect of the disclosed subject matter.

FIG. 11 is a side view of still another embodiment of eyewear according to another aspect of the disclosed subject matter.

FIG. 12 is a side view of the tab of FIG. 11.

FIG. 13 is a top view of the tab of FIG. 14.

FIG. 14 is a front view of another embodiment of eyewear according to another aspect of the disclosed subject matter.

FIG. 15 is a close-up view of the display face of FIG. 14.

### DETAILED DESCRIPTION OF EXEMPLARY EMBODIMENTS

Figures shown and described herein are provided in order to illustrate key principles of operation and fabrication for eyewear according to various embodiments of the disclosed subject matter, and a number of these figures are not drawn with intent to show actual size or scale. Some exaggeration may be necessary in order to emphasize basic structural relationships or principles of operation. Where they are used, the terms “first”, “second”, and so on, do not necessarily denote any ordinal or priority relation, but may be simply used to more clearly distinguish one element from another.

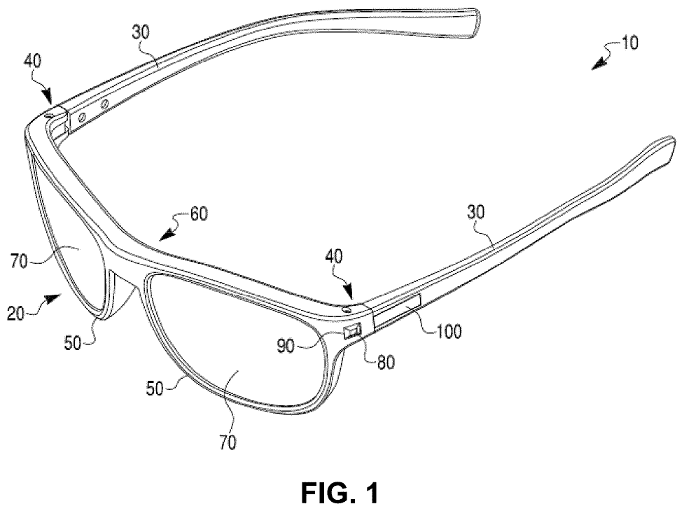

FIG. 1 is a front and left side perspective view of an embodiment of eyewear 10 made in accordance with principles of the disclosed subject matter. The structures and methods disclosed herein can be used or applied to various different forms of eyewear, including eyeglasses, shields, goggles, etc. Furthermore, the disclosed structures and methods are applicable to eyewear with one or more electronic displays in addition to or instead of lenses. The eyewear 10 can include a frame 20 and a pair of arms 30 extending from opposing sides of the frame 20 for positioning the eyewear 10 on a wearer's head. The frame 20 can include a pair of lens supports 50 on either side of a nose bridge 60 configured to support lenses 70 therein. Some embodiments of the frame 20 can include a single lens support 50 extending from one side of the nose bridge 60 to the other for supporting a single lens (such as commonly used in goggle type devices or sports eyewear frames). The nose bridge 60 can be formed by opposing inward-facing portions of the lens supports 50 connected by a central portion of the frame 20. In some embodiments, the nose bridge 60 can be formed as a strut integrated as part of the frame 20, lens supports 50, lenses 70, etc.

In the embodiment shown in FIG. 1, the lens supports 50 are shown to completely surround the respective lenses 70. However, the lens supports 50 may alternatively only partially surround the lenses 70, such as in embodiments in which a support extends along only upper or lower portions of the lenses 70. Further, embodiments may comprise rimless eyewear, in which the arms 30 and/or the nose bridge 60 are mounted directly to the lenses 70, without supports for the lenses or a frame. Additionally, although the illustrated eyewear 10 includes the pair of lens supports 50 for supporting the pair of lenses 70 in the frame 20, other arrangements may include a single, unitary lens extending across both left and right eyes of the wearer, with or without frame support.

Each of the arms 30 can be permanently or removably attached to various portions of the frame 20, lens supports 50, lenses 70, etc., to position the eyewear 10 on the wearer's head. Each of arms 30 can be attached to an outer portion, i.e., at a temple portion of the respective lens support 50. As illustrated in FIG. 1, the arms 30 of the present embodiment can be attached to opposing outer portions, or temples 22, of the lens supports 50 of the frame 20.

Each of the arms 30 can extend rearwardly from its point of attachment to frame 20 when the arms 30 are in the unfolded or opened position, i.e., for wearing, as illustrated in FIG. 1. Conversely, when the arms 30 are in the folded or closed position, i.e., for storage, each of the arms 30 can extend inwardly or medially from its point of attachment to the frame 20. Portions of the arms 30 can be integrally or separately formed with portions of the frame 20 such as the lens supports 50, lenses 70 and/or any intermediate support structure. The frame 20 and arms 30 can comprise any of many different shapes, sizes, materials and configurations. Injection molding, stamping, forging, casting, machining, and other construction techniques for these components can be used. The materials for constructing the frame 20 can include metals, plastics, wood, ceramics, glass, and combinations thereof.

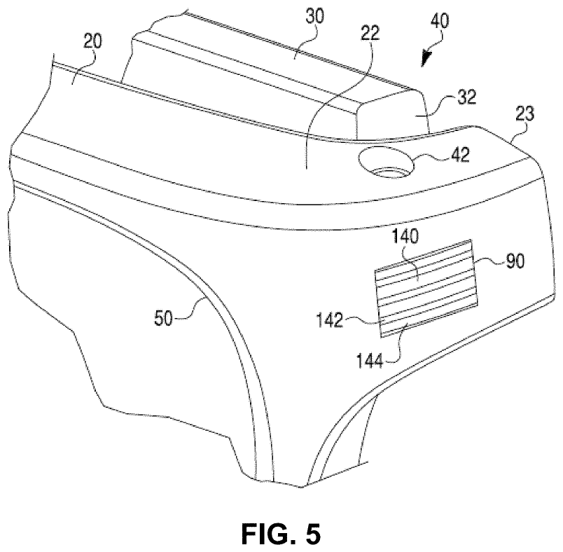

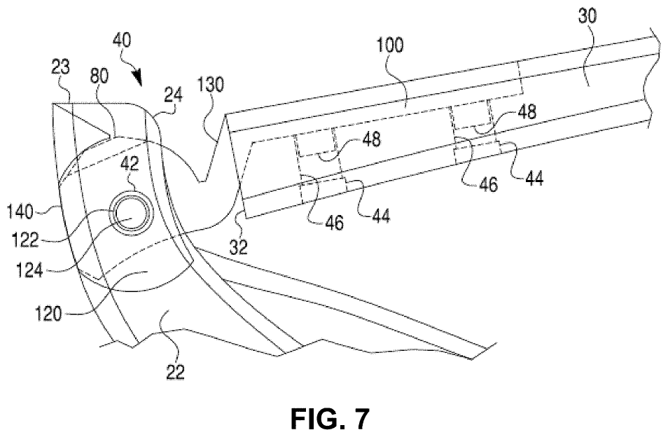

In some embodiments, the arms 30 can be attached to the frame 20 by respective hinge assemblies 40 to facilitate movement of the arms 30 between folded and unfolded positions relative to the frame 20. FIGS. 1-4 and 6 show examples of the eyewear 10 with the arms 30 in the unfolded position, and FIGS. 5 and 7 show examples of the eyewear 10 with the arms 30 in the folded or stored position. Referring to FIG. 1, in some embodiments, the hinge assemblies 40 can include revolving display faces including a first face 80, as described further herein.

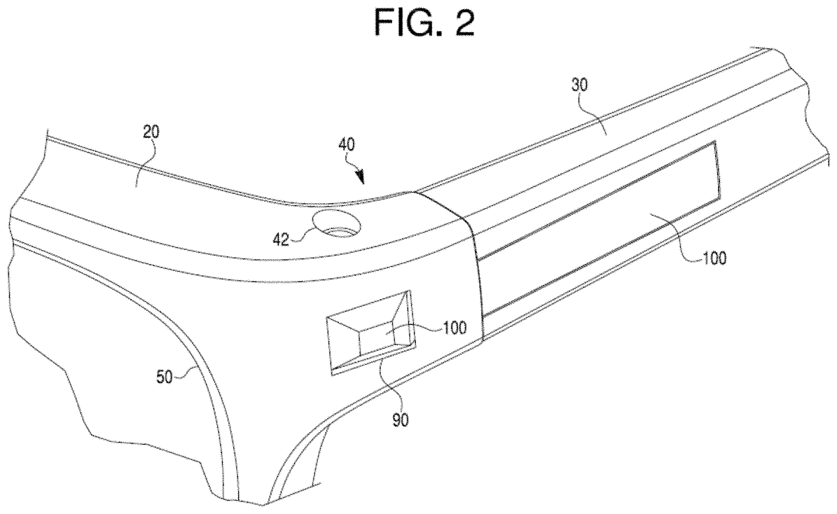

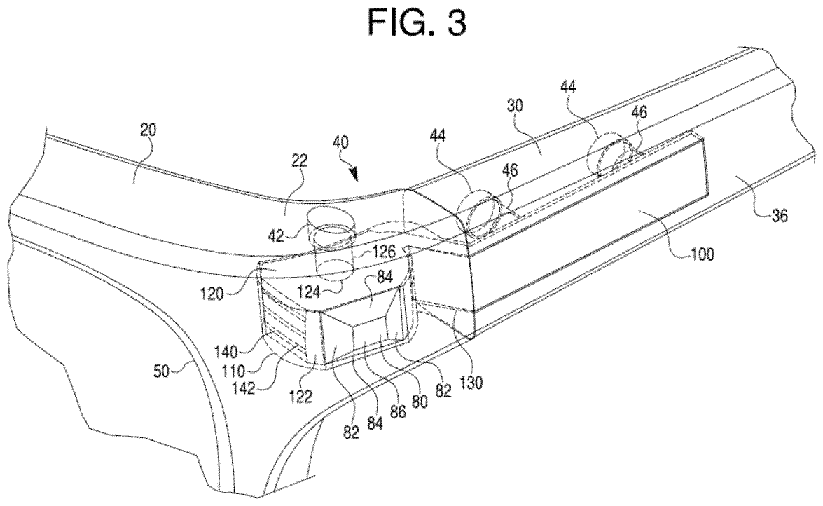

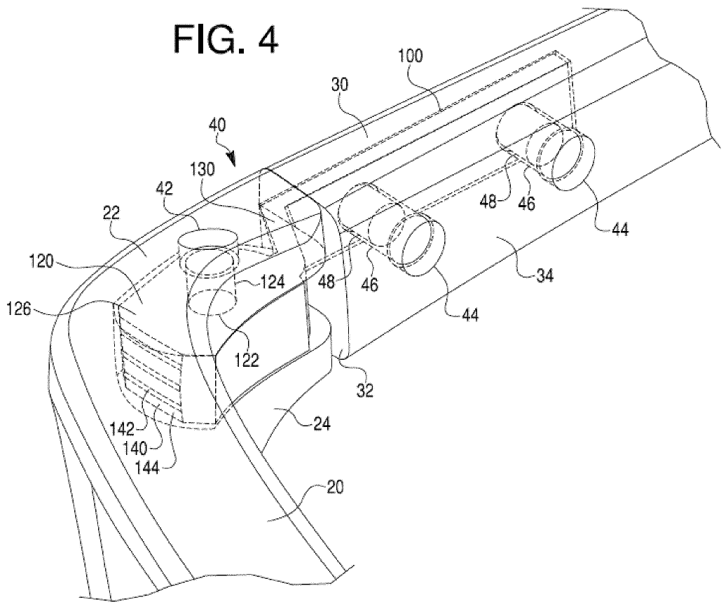

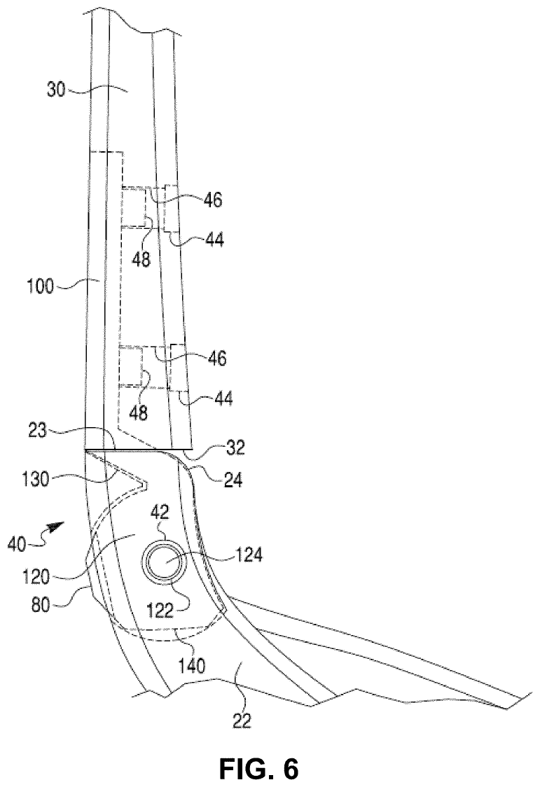

FIGS. 2-3 are enlarged perspective views of an embodiment of the hinge assembly 40 of the eyewear 10, shown here to include the first face 80 displayed through a cutout 90 or window in the temple 22 of the frame 20. FIG. 4 is an enlarged perspective view of the opposing hinge assembly 40 with internal components shown in phantom, and FIG. 5 is an enlarged perspective view of the hinge assembly 40 and portion of the extending arm 30 in the folded or closed position. FIGS. 6 and 7 are top views of the opposing hinge assembly 40 and portion of the extending arm 30 in the unfolded or open position and the folded or closed position, respectively, with internal components shown in phantom.

Referring to FIGS. 2-7, each of the hinge assemblies 40 can comprise one or more rotational elements configured to be pivotable with respect to each other about a pivot axis to allow the respective arm 30 to be moved between the folded and unfolded position. The rotational elements can comprise any of many structures that permit rotational movement, such as a hub, lug, bearing, bushing, hinge, pin, ball and pinion, axle, rotational joint, magnetic joint, and the like, or various combinations thereof. In the illustrated embodiment, the hinge assembly 40 can include a swivel portion 120 as the rotational element. A cavity 110 in the temple 22 of the frame 20 can be configured to receive the swivel portion 120, and can include a pin 126 that extends through the swivel portion 120 to thereby facilitate rotation of the swivel portion 120 about the pivot axis with respect to the frame 20. The pin 126 can be retained by the swivel portion 120 and the cavity 110 in a variety of lateral and/or axial directions with respect to the pivot axis. The cavity 110 can retain the swivel portion 120 therein via the pin 126 extending through a frame pinhole 42 in the temple 22 and an aligned swivel pinhole 124. The cavity 110 can further include one or more retaining elements, for example, one or more flares, flanges, burrs, clips, cotter pins, or other retaining portions that may retain the swivel portion 120 and/or the pin 126 with respect to each other.

Rotational elements such as the swivel portion 120 and the pin 126 can be attached to various portions of frame 20, and can be a separate or integral (unitary) construction with respect to frame 20. In the exemplary embodiment, swivel portion 120 is attached to arm 30 via tab 100, and the pin 126 is separately formed to engaged with the temple 22 of the frame 20 at the cavity 110. Rotational elements can be permanently or removably attached to frame 20 in many ways, such as with fasteners, threaded engagement, adhesives, welding, soldering, ultrasonic bonding, friction fit, press fit, snap fit, clips, and the like. Rotational elements can be positioned at various points along the frame 20. For example, the swivel portion 120 can be positioned proximate to a proximal end of arm 30, such that arm 30 pivots approximately about its proximal end. The cavity 110 can be disposed proximate a distal portion of the temple 22, wherein the proximal portion of the temple 22 is adjacent the lens support 50.

The rotational elements such as the swivel portion 120 and the pin 126 can be made from any of a variety of materials with sufficient rigidity to withstand the lateral, axial, rotational, and/or torsional forces resulting when the eyewear 10 is positioned on the head of the wearer, and when the arms 30 are folded against and unfolded from the frame 20. In some embodiments, the swivel portion 120 and the pin 126 can comprise a material with a coefficient of friction sufficient to allow sliding engagement between opposed, contacting surfaces of the cavity 110, while still allowing, in some embodiments, resistance to movement between any, some or substantially all of these contacting surfaces. The swivel portion 120 and the pin 126, as well as the cavity 110 of the frame 20, can comprise the same or different material with respect to each other, such as plastic or metal. Rubberized or elastomeric materials can also be used. These rotational elements can comprise more than one material, such as a composite, or a metal coated with rubber, plastic, or foam. For instance, swivel portion 120 and the pin 126, as well as the cavity 110 of the frame 20 can be thermally, chemically or mechanically treated to provide, or can comprise any material that provides, increased durability, flexibility, moisture absorption or adsorption, and/or chemical resistance. These rotational elements can include a material of any color, and can be a substantially transparent, opaque, or translucent material, or any combination thereof for aesthetic reasons. In the present embodiment, the frame 20 is substantially opaque at the temple 22 to hide surfaces of the swivel portion 120 not visible through the cutout 90, as described in more detail below.

In some embodiments, the swivel portion 120 can include a tab 100 extending rearward from the cavity 110. Specifically, the tab 100 can include a transition portion 130 extending rearwardly from the swivel portion 120 to an elongated portion aligned with the arm 30. The transition portion 130 can be substantially disposed within an extension of the cavity 110 in the frame 20 when the respective arm 30 is unfolded or in the open position, and exposed when folded or in the closed position, as shown in FIG. 7. The tab 100 can be configured to conform to and/or engage with a corresponding portion of the arm 30 such that the tab 100 is secured to a forward portion 36 of the arm 30 via fasteners 48 inserted therethrough, as shown in FIG. 4. The fasteners 48 can be inserted into openings 44 and through holes 46 in inward-facing sides of the arms 30. The tabs 100 can be used to provide a certain aesthetic appeal and/or provide a smooth transition from the temple 22 of the frame 20 to the arm 30. Alternatively, the tabs 100 can be totally embedded or molded into the arm 30 such that tabs 100 cannot be seen when the eyewear is in use.

Referring again to FIGS. 3-7, the temple 22 of the frame 20 can include the cutout 90 to the cavity 110. The first face 80 of the swivel portion 120 is viewable through the cutout 90 when the arms 30 are in the are in the open or unfolded position. In the present embodiment, the cutout 90 and the first face 80 are rectangular and have substantially aligned perimeters. Particularly, the first face 80 has a raised central portion 86 and sloping sides 82,84. The central portion 86 can be raised from the cutout 90 so as to protrude therefrom, or may alternatively be flush with the cutout 90 or even concave so as to be spaced inward from the cutout 90 into the cavity 110. The first face 80 can be further configured to include various decorative displays such as, for example, reflectors and/or lights (e.g., LED, halogen, luminescent material) or trademark logos, designs, etc.

The swivel portion 120 of the present embodiment can also include a second face 140 disposed proximate the first face 80 and separated by an intermediate panel 122. In some embodiments, the first and second faces 80,140 can be arranged approximately orthogonally to each other, with the second face 140 configured to be viewable through the cutout 90 when the respective arm 30 is in the closed or folded position. Other embodiments may include the first and second faces 80,140 disposed at acute or obtuse angles to each other. The second face 140 of the present embodiment can be configured to have alternating grooves 142 and ridges 144 to form a decorative display visible through the cutout when the arm 30 is in the closed or folded position, and hidden when the arm 30 is in the open or unfolded position. Similarly, the first face 80 can be configured with a decorative display visible through the cutout 90 when the arm 30 is in the open or unfolded position, and can be partially or totally hidden when the arm 30 is in the closed or folded position. This arrangement facilitates different displays through the cutouts 90 in the frame 20 depending on the position of the arms 30, and whether the arms 30 are unfolded or folded.

The cavity 110 can be formed in the temple 22 of the frame 20 to have a complementary shape to the swivel portion 120 such that the swivel portion 120 can rotate uninhibitedly therein. Particularly, the swivel portion 120 can rotate between positions corresponding to those of the arms 30 in the unfolded and folded positions. A clearance fit can be provided between the rotational elements such as the swivel portion 120 and the pin 126, and the cavity 110 in the frame 20 to allow the swivel portion 120 and attached arm 30 to rotate with respect to the frame 20. With such a clearance fit, rotational resistance between the swivel portion 120 and the cavity 110 can be provided to ensure that the swivel portion 120 does not rotate within the cavity 110 without due force, thereby maintaining intended positioning of the arm 30. The cavity 110 can engage with and/or retain the rotational elements such as the swivel portion 120 and the pin 126 through direct contact, or attachment to an intermediary structure (such as a bushing, sleeve, etc.) positioned between the cavity and the rotational elements. In some embodiments, the cavity 110 can be configured to engage with the swivel portion 120 so as to resist rotational motion of the swivel portion 120 to assist the arm 30 in maintaining either the open and unfolded position or the closed and folded position. In some embodiments, the cavity 110 of the frame 20 can comprise a material with a coefficient of friction sufficient to allow rotational engagement between contacting surfaces of the swivel portion 120, while still allowing, in some embodiments, resistance to movement between any, some or substantially all of these contacting surfaces. The pin 126 can be inserted through a pinhole 42 in the temple 22 and aligned pinhole 124 through the swivel portion 120. The swivel portion 120 can thereby rotate about the pin 126 within the cavity 110. In addition, certain cam-like or lock structures can be provided or built into the cavity wall and/or swivel portion 120 such that the arm 30 can be “locked” or urged into certain positions, such as the totally folded or totally unfolded positions.

Referring to FIGS. 4 and 6, the opposing hinge assembly 40 is shown with internal components shown in phantom. As shown in FIG. 4, the fasteners 48 can be inserted into the openings 44 and through the holes 46 in the inward-facing side of the arm 30 to secure the swivel portion 120 to the arm 30 via the tab 100. The fasteners 48 can be screws, bolts, pins, adhesive, or any other suitable fixture hardware or material. Furthermore, the present embodiment shown in FIG. 4 includes a pair of the fasteners 48, however any appropriate number of fasteners may be used such as one, two, three, four, five, etc.

The arm 30 as shown in FIG. 4 can also have a substantially flat hinge side 32 configured to abut the frame 20 when the arm 30 is in the open or unfolded position. As the arm 30 rotates inward to the folded or closed position, the hinge side 32 moves across an inner side 24 of the frame 20. The inner side 24 can include a corresponding tapered, radiused or curvilinear portion. As shown in FIG. 5 and described in more detail below, the hinge side 32 of the arm 30 may be spaced from the inner side 24 of the frame when the arm 30 is in the closed or folded position, unlike in the open or unfolded position.

Referring to FIGS. 5 and 7, the hinge assembly 40 and portion of the extending arm 30 is shown in the folded or closed position. As shown, when the arm 30 of the present embodiment is folded into the closed position against the frame 20, the second face 140 of the swivel portion 120 is visible through the cutout 90 in the temple 22. As described above, the second face 140 is shown with the grooves 142 and ridges 144 extending horizontally, however various other decorative displays may be implemented on the second face 140, and the second face 140 of the present embodiment is shown for exemplary purposes only. The cutout 90 is shown to be rectangular, as is the second face 140, however other embodiments may have otherwise shaped cutouts and faces including circular, triangular, diamond-shaped, etc. Shapes of the first and second faces 80,140 may correspond to the shape of the cutout 90, or may be shaped differently. With the arm 30 rotated to the closed and folded position, the hinge side 32 is spaced from a rear side 23 of the frame 20 such that both are exposed.

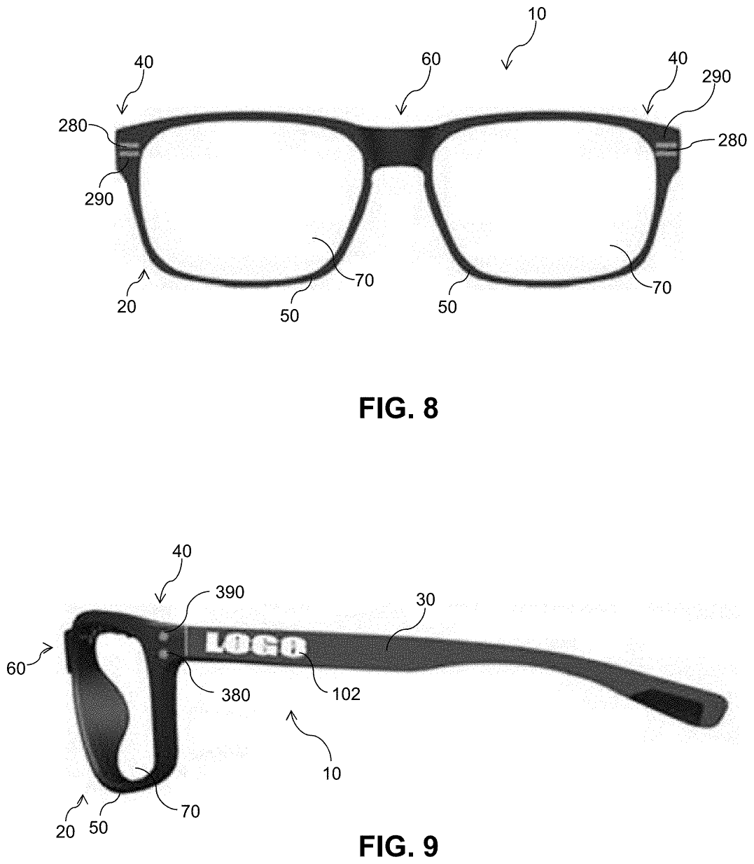

FIG. 8 shows yet another embodiment of an eyewear device consistent with the principles of the presently disclosed subject matter. In this embodiment, the hinge assemblies 40 can each include respective front-facing cutouts 290 in the frame 20 at the temples 22. The cutouts 290 can be configured similarly to the cutouts 90 described above for the embodiments shown in FIGS. 1-7, however a display face 280 (first face) is visible from the front of the eyewear 10 through the cutout 290 when the respective arm 30 is in the open and unfolded position. The embodiment shown in FIG. 8 includes the display face 280 having a pair of horizontal bars such that the pair of bars are visible through the cutout 290 when the arm 30 is in the open and unfolded position. Other embodiments may include any number of horizontally extending bars, including one, two, three, four, etc. The cutout 290 of the present embodiment can include a cross member extending therethrough, the cross member defining two separate openings that the display face 280 can be visible through. Each of the horizontal bars of the display face 280 can be visible through corresponding openings in the cutout 290, and may even protrude at least partially through the separate openings. Another display face (second face) can thus be configured to be visible through the cutouts 290 when the arms are in the closed and folded position similar to the embodiments described above and shown in FIGS. 1-7, but the other display face will also be visible from the front of the eyewear 10 just as the display face 280 is visible. This configuration requires disposing the display face 280 and the other display face (not shown) at locations on the swivel portions of the arms 30 that are rotated approximately 90 degrees from the first face 80 and the second face 140 of the previously described embodiments. Thus, the display face 280 is disposed on a front side of the swivel portion of the arm while the other display face is disposed on an inner side of the swivel portion.

FIG. 9 shows another embodiment of an eyewear device consistent with the principles of the presently disclosed subject matter. In this embodiment, the hinge assemblies 40 can each include respective side-facing cutouts 390 in the frame 20 at the temples 22. The cutouts 390 can be configured similarly to the cutouts 90 described above for the embodiments shown in FIGS. 1-7, with a display face 380 (first face) being visible from the side of the eyewear 10 through the cutout 390 when the respective arm 30 is in the open and unfolded position. The embodiment shown in FIG. 9 includes the display face 380 having a pair of dots such that the pair of dots are visible through the cutout 390 when the arm 30 is in the open and unfolded position. Other embodiments may include any number of dots, including one, two, three, four, etc. The dots of the display face 380 can be ovular, such as circular, or otherwise shaped. The cutout 390 of the present embodiment can include a cross member extending therethrough, the cross member defining two separate openings that the display face 380 can be visible through. Each of the dots of the display face 380 can be visible through corresponding openings in the cutout 390, and may even protrude at least partially through the separate openings. Another display face (second face) can thus be configured to be visible through the cutouts 290 when the arms are in the closed and folded position similar to the embodiments described above and shown in FIGS. 1-7.

Additionally, some embodiments can include a side display 102 disposed on the side of the arms 30. The side display 102 can be flush with an outer surface of the side of the arms 30, or may be raised so as to protrude from the outer surface. The side display 102 can be configured as a single piece or may include multiple pieces such as letters to form emblems, logos, symbols, etc. The side display 102 can be attached to the arm 30 from an inner side, or may alternatively be attached from the outer side on which the side display 102 is visible. Further, the display face 380 can provide a missing ornamental piece of the side display. For example, instead of two dots, the display could take the shape of the letter “L” with the letters “OGO” being located on the arm, such that the display face 390 completes the word “LOGO” when the arm 30 is in the open unfolded position.

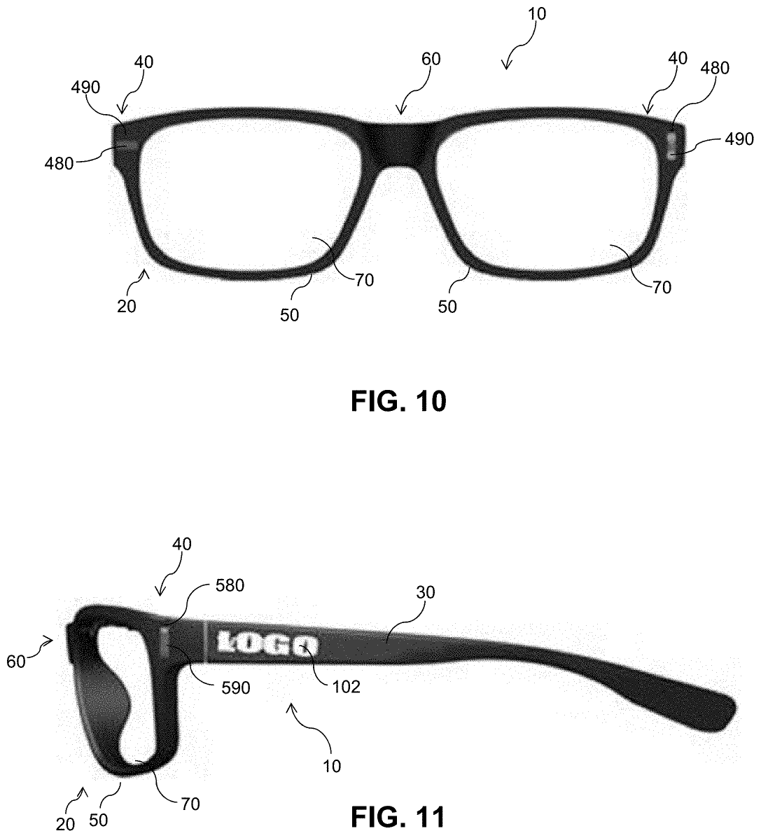

FIG. 10 shows another embodiment of an eyewear device consistent with the principles of the presently disclosed subject matter. In this embodiment, the hinge assemblies 40 can each include respective front-facing cutouts 490 in the frame 20 at the temples 22. The cutouts 490 can be configured similarly to the cutouts 290 described above for the embodiment shown in FIG. 8, with a display face 480 (first face) being visible from the front of the eyewear 10 through the cutout 490 when the respective arm 30 is in the open and unfolded position. The embodiment shown in FIG. 10 includes the display face 480 having a single horizontal bar such that the bar is visible through the right-side cutout 490 when the arm 30 is in the open and unfolded position. Other embodiments may feature the display face 480 with the single horizontal bar on the other arm 30 so as to be visible through the left-side cutout 490, and further embodiments can include the display face 480 having the single horizontal bar on both of the arms 30. The single horizontal bar of the display face 480 can be visible through an opening in the cutout 490, and may even protrude at least partially through the opening. Another display face (second face) can thus be configured to be visible through the cutout 490 when the arm is in the closed and folded position similar to the embodiments described above, with the other display face visible from the front of the eyewear 10 just as the display face 480 is visible. The embodiment shown in FIG. 10 can also have the display face 480 of each of the arms 30 configured differently such that the right-side arm 30 has a design that is different from the single horizontal bar of the display face 480 of the left-side arm 30. The right-side display face 480 shown can be a single vertical bar, or a pair of vertically aligned dots as described above with regard to FIG. 9. Any number of configurations may be implemented in which each of the pair of display faces 480 differ from one another in orientation, design, shape, size, etc.

FIG. 11 shows another embodiment of an eyewear device consistent with the principles of the presently disclosed subject matter. In this embodiment, the hinge assemblies 40 can each include respective side-facing cutouts 590 in the frame 20 at the temples 22. The cutouts 590 can be configured similarly to the cutouts 390 described above for the embodiment shown in FIG. 9, with a display face 580 (first face) being visible from the side of the eyewear 10 through the cutout 590 when the respective arm 30 is in the open and unfolded position. The embodiment shown in FIG. 11 includes the display face 380 having a vertical bar such that the vertical bar is visible through the cutout 590 when the arm 30 is in the open and unfolded position. The vertical bar of the display face 580 can be visible through the opening in the cutout 590, and may even protrude at least partially through the openings. Another display face (second face) can thus be configured to be visible through the cutouts 590 when the arms are in the closed and folded position similar to the embodiments described above and shown in FIG. 9.

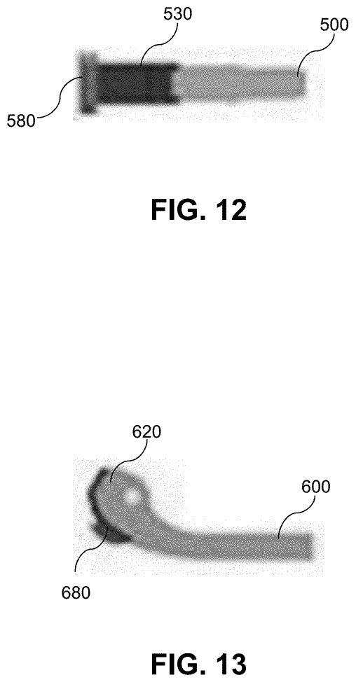

Referring to FIGS. 12 and 13, the hinge assemblies 40 of some embodiments can incorporate temple stem portions that are friction fit to the frame 20. As shown in FIG. 12, the stem portion can include a tab 500 connected to a transition portion 530, the transition portion 530 being configured as a swivel portion with a display face 580 disposed thereon. The display face 580 can be a vertical bar, or otherwise configured, as described above and shown in FIGS. 1-11. As shown in FIG. 13, the stem portion can include a tab 600 connected to a swivel portion 620 with a display face 680 disposed thereon. The display face 680 can be configured as described above and shown in FIGS. 1-11.

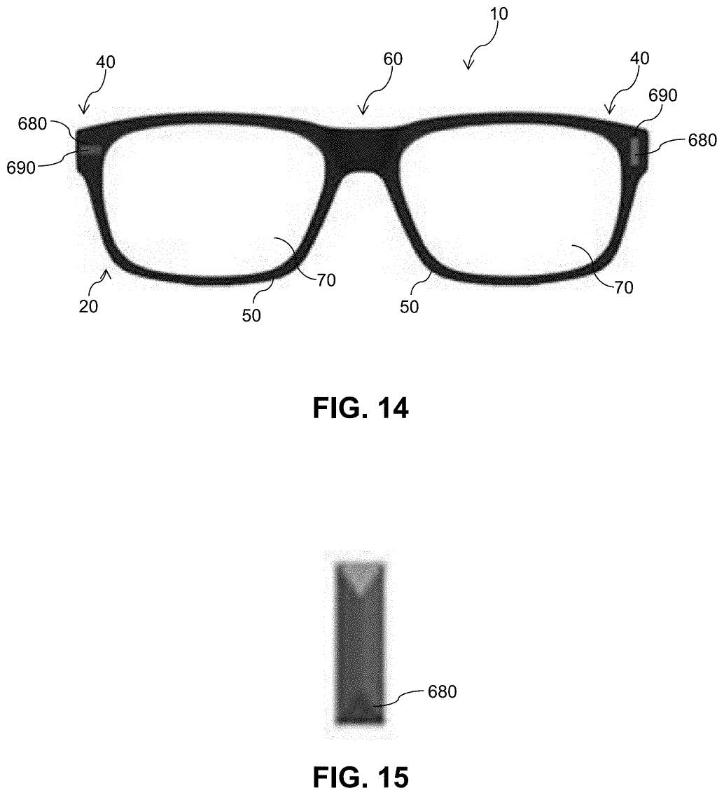

FIG. 14 shows another embodiment of an eyewear device consistent with the principles of the presently disclosed subject matter. In this embodiment, the hinge assemblies 40 can each include respective front-facing cutouts 690 in the frame 20 at the temples 22. The cutouts 690 can be configured similarly to the cutouts 490 described above for the embodiment shown in FIG. 10, with a display face 680 (first face) being visible from the front of the eyewear 10 through the cutout 690 when the respective arm 30 is in the open and unfolded position. The embodiment shown in FIG. 14 includes each of the display faces 680 having different configurations, with the left-side display face 680 having a vertical bar as described in FIG. 11 and shown in greater detail in FIG. 15, and the right-side display face 680 having a horizontal bar as described in FIG. 10. Both the right-side and the left-side display faces 680 are visible through the respective cutouts 690 when the arms 30 are in the open and unfolded position. Other embodiments may feature the display faces 680 being switched such that the left-side display face 680 has a horizontal bar and the right-side display face 680 has a vertical bar. The bars of the display faces 680 can be visible through openings in the cutouts 690, and may even protrude at least partially through the openings. Another display face (second face) of each of the arms 30 can thus be configured to be visible through the respective cutouts 690 when the arms are in the closed and folded position similar to the embodiments described above and shown in FIGS. 9 and 10, with the other display face visible from the front of the eyewear 10 just as the display face 680 is visible. Any number of configurations may be implemented in which each of the pair of display faces 680 differ from one another in orientation, design, shape, size, etc.

In some embodiments, the cutout 90, 290, 390, 490, 590, 690 can be disposed in portions of the frame 20 other than the temple 22. For example, the cutout 90, 290, 390, 490, 590, 690 may be disposed in part of the lens support 50. The cutout 90, 290, 390, 490, 590, 690 can also be larger or smaller than depicted in the exemplary embodiments shown in FIGS. 1-7. The cutout 90, 290, 390, 490, 590, 690 may extend over substantially an entirety of the temple 22, or may alternatively extend over a minority portion of the temple 22. Shapes of the cutout 90, 290, 390, 490, 590, 690 may also be varied beyond the rectangle shown, to include circular, triangular, diamond-shaped, etc. The rectangular shape shown can also be oriented vertically as opposed to horizontally, as shown. In other embodiments, the cutout 90, 290, 390, 490, 590, 690 may comprise multiple cutouts such as two, three, four, five, etc. such that multiple faces or portions of faces of the swivel portion 120 can be displayed through the corresponding cutouts when the arm 30 is in either the open and unfolded position or the closed and folded position. The cutout 90 can be totally encircled or encompassed by the frame 20, as shown, or can include one or more sides that are open or exposed (i.e., not encircled, encompassed or “framed” by the frame 20).

In some embodiments, the swivel portions 120 may have more than a pair of faces to be visible through the cutout 90 at open and closed positions of the arms 30. For example, the swivel portions 120 may include a third face between the first and second faces 80,140 that is visible through the cutout 90, 290, 390, 490, 590, 690 when the respective arm 30 is in an intermediary position between open and closed. Any number of decorative display faces may be disposed on surfaces of the swivel portion 120, with each face being visible through the cutout 90, 290, 390, 490, 590, 690 in accordance with a predetermined position of the connected arm 30 with respect to the frame 20. For example, a light or design can be located on a face between the first and second faces 80,140 that is visible through the cutout 90, 290, 390, 490, 590, 690 when the respective arm 30 is in an intermediary position between open and closed to warn or notify a user that the eyewear is not in the fully open or closed position.

In some embodiments, a cover can extend across the cutouts 90 to form a barrier between the cavity 110 and an exterior of the frame 20. The cover can be transparent or translucent and extend between edges of the cutout 90, 290, 390, 490, 590, 690 or alternatively extend over the cutout 90290, 390, 490, 590, 69, either on the interior or exterior surfaces of the frame 20. The cover can thus be configured such that decorative displays on faces of the swivel portion 120 are visible when the arms 30 are rotated to the corresponding positions.

In some embodiments, the hinge assemblies 40 will feature hinge mechanisms other than those illustrated in the present embodiment. For instance, the hinge assemblies 40 may include spring hinges, screwless hinges, live hinges, etc. The hinge assembly 40 utilizing the pin 126 in the present embodiment is for exemplary purposes only, and the alternating display faces of the swivel portion 120 extending from the arm 30 may be utilized in eyewear having various different types of hinges.

Although certain embodiments and examples have been discussed herein, it will be understood by those skilled in the art that the presently disclosed subject matter extends beyond the specifically disclosed embodiments to other alternative embodiments and/or uses of the disclosed subject matter and obvious modifications and equivalents thereof. In addition, while a number of variations of the disclosed subject matter have been shown and described in detail, other modifications, which are within the scope of this disclosed subject matter, will be readily apparent to those of skill in the art based upon this disclosure. It is also contemplated that various combinations or sub-combinations of the specific features and aspects of the embodiments may be made and still fall within the scope of the disclosed subject matter. Accordingly, it should be understood that various features and aspects of the disclosed embodiments can be combined with or substituted for one another in order to form varying modes of the disclosed subject matter. Thus, it is intended that the scope of the present invention herein disclosed should not be limited by the particular disclosed embodiments described above, but should be determined only by a fair reading of the present disclosure, including the appended claims.

1. Eyewear, comprising:
a frame having at least one cavity disposed at one side thereof, the cavity being formed adjacent a cutout in the frame; and
at least one arm rotationally connected to the frame by a swivel portion, the swivel portion configured to be disposed and rotate within the cavity such that a plurality of surfaces of the swivel portion are viewable through the cutout.

2. The eyewear of claim 1, further comprising another cavity disposed at an opposing side of the frame, the other cavity being formed adjacent another cutout in the frame; and
another arm rotationally connected to the frame by another swivel portion, the other swivel portion configured to be disposed and rotate within the other cavity such that a plurality of surfaces of the other swivel portion are viewable through the other cutout.

3. The eyewear of claim 1, wherein the cutout extends through the frame from an exterior surface of the frame to an interior surface of the frame.

4. (canceled)

5. (canceled)

6. The eyewear of claim 1, wherein the swivel portion is separately and distinctly formed from the arm.

7. The eyewear of claim 1, wherein at least one of the plurality of surfaces of the swivel portion includes a surface that is substantially flat and disposed along a plane substantially parallel with an axis about which the swivel portion rotates with respect to the cavity.

8. The eyewear of claim 1, further comprising a transparent cover disposed adjacent the cutout such that the plurality of surfaces of the swivel portion are viewable through the transparent cover when the arm is rotated with respect to the frame.

9. The eyewear of claim 1, wherein the cutout is configured such that a first surface of the plurality of surfaces is viewable through the cutout from a first vantage point, and a second surface of the plurality of surfaces is obscured from view through the cutout from the first vantage point if the arm is oriented in a first position.

10. The eyewear of claim 9, wherein the cutout is configured such that the first surface is not viewable through the cutout from the first vantage point, and the second surface is viewable through the cutout from the first vantage point if the arm is oriented in a second position.

11. The eyewear of claim 1, wherein each of the plurality of surfaces of the swivel portion are viewable through the cutout at distinct rotational positions of the arm relative to the frame.

12. The eyewear of claim 11, wherein each of the plurality of surfaces of the swivel portion are configured to project through the respective cutout at the distinct rotational positions of the arm at which the surface is viewable.

13. The eyewear of claim 11, wherein each of the plurality of surfaces of the swivel portion are configured to be flush with the respective cutout at the distinct rotational positions of the arm at which the surface is viewable.

14. The eyewear of claim 11, wherein the plurality of surfaces of the swivel portion are configured such that a first surface is visible through the cutout when the swivel portion is at a first rotational position and a second surface is visible through the cutout when the swivel portion is at a second rotational position.

15. (canceled)

16. (canceled)

17. (canceled)

18. Eyewear with a frame and a pair of arms, each arm being connected to the frame by a respective hinge, the eyewear comprising:
a pair of connectors, each connector being attached to the frame and the respective arm to form the respective hinge, each connector comprising:
an elongated portion extending along and attached to a portion of the respective arm adjacent the frame; and
a swivel portion connected to the elongated portion and disposed within a cavity in the frame, wherein
the swivel portion has a plurality of faces configured to be displayed through a cutout to the cavity in the frame, each of the plurality of faces being displayed at corresponding rotational positions of the swivel portion.

19. The eyewear of claim 18, wherein each of the plurality of faces are configured to project through the cutout when displayed at the corresponding rotational positions of the swivel portion.

20. The eyewear of claim 18, wherein each of the plurality of faces are configured to be flush with the cutout when displayed at the corresponding rotational positions of the swivel portion.

21. The eyewear of claim 18, wherein the plurality of faces are configured on surfaces of the swivel portion such that a first face is visible through the cutout when the swivel portion is at a first rotational position and a second face is visible through the cutout when the swivel portion is at a second rotational position.

22. The eyewear of claim 21, wherein the first rotational position of the swivel portion corresponds to the respective arm being extended from the frame, and the second rotational position of the swivel portion corresponds to the respective arm being collapsed against the frame.

23. The eyewear of claim 22, wherein the first face is configured to project through the cutout when the swivel portion is at the first rotational position.

24. The eyewear of claim 23, wherein the second face is configured to be flush with the cutout when the swivel portion is at the second rotational position.

25. (canceled)

26. (canceled)

27. (canceled)

28. (canceled)

29. (canceled)

30. A method of using eyewear, comprising:
providing a frame defining a lens support and at least one cutout located adjacent the lens support, a first hinge connected to a first arm at one side of the frame, a second hinge connected to a second arm at an opposing side of the frame, a first decorative surface located adjacent the cutout, and a second decorative surface distinct from the first decorative surface located adjacent the cutout;
rotating the first arm about the first hinge to a first position such that the first decorative surface is viewable through the cutout from a first vantage point, and such that the second decorative surface is obscured from view through the cutout from the first vantage point; and
rotating the first arm about the first hinge to a second position such that the second decorative surface is viewable through the cutout from the first vantage point, and such that the first decorative surface is obscured from view through the cutout from the first vantage point.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)
